(19) United States
(12) Patent Application Publication
(10) Pub. No.: US 2024/0393987 A1
(43) Pub. Date: Nov. 28, 2024

(54) IMAGE FORMING SYSTEM, INFORMATION PROCESSING APPARATUS AND NON-TRANSITORY RECORDING MEDIUM STORING COMPUTER READABLE CONTROL PROGRAM

(71) Applicant: KONICA MINOLTA, INC., Tokyo (JP)

(72) Inventor: Ryo Mitsuda, Tokyo (JP)

(73) Assignee: KONICA MINOLTA, INC., Tokyo (JP)

(21) Appl. No.: 18/633,943

(22) Filed: Apr. 12, 2024

(30) Foreign Application Priority Data
May 22, 2023 (JP) 2023-083664

(51) Int. Cl. G06F 3/12; G03G 15/00; G03G 15/20

(52) U.S. Cl. CPC G06F 3/1208; G03G 15/2003; G03G 15/5025; G06F 3/1261

(57) ABSTRACT

An image forming system includes a hardware processor that determines an image formation condition for each of a plurality of image forming apparatuses based on sheet characteristic information corresponding to a characteristic of a sheet acquired from each of the plurality of image forming apparatuses.

### CROSS-REFERENCE TO RELATED APPLICATION

The entire disclosure of Japanese patent application No. 2023-083664, filed on May 22, 2023, is incorporated herein by reference in its entirety.

### BACKGROUND OF THE INVENTION

### 1. Technical Field

The present invention relates to an image forming system, an information processing apparatus and a non-transitory recording medium storing a computer readable control program.

### 2. Description of Related Art

There is a technique called distributed printing in which, when a print job for a large number of prints are output, one print job is split into a plurality to be executed by a plurality of image forming apparatuses. In a printing system disclosed in Patent Literature 1 (Japanese Unexamined Patent Application Publication No. 2009-26203), the following technique is used to avoid an issue in which when one print job is output from a plurality of printing apparatuses with the distributed printing, the printed products thereof includes a plurality of sheet types. Each printing apparatus includes a media sensor for determining the paper type set in the sheet feed trays to collect the paper types read by the media sensor, and transmits the split jobs to only printing apparatuses in which the same paper type is set.

However, even when the printing is executed using the same sheet type, the image quality such as color tone may vary. For example, even in a case of the same sheet type, different image quality is obtained due to difference in the water content state of the papers, and even in the case of using the same sheet type, different image quality is obtained depending on the states of the machines. In order to cope with such an issue, in Patent Literature 2 (Japanese Unexamined Patent Application Publication No. 2021-26243), when a plurality of image forming apparatuses performs image formation, the color tone of the image on each sheet after the image formation is detected by a color tone detector. Then, a technique of correcting the color tone of the image by comparing the pieces of color tone data detected by the color tone detectors of the plurality of printing machines is disclosed.

### SUMMARY OF THE INVENTION

However, in the technique of Patent Literature 2, the image after the image formation is detected by the color tone detector, and the color tone is corrected according to difference in the color tone. Thus, it takes an adjustment time until the color tone correction is reflected, and the productivity may decrease.

The present invention has been made in view of the above-described circumstances, and an object of the present invention is to equalize, in printing using a plurality of image forming apparatuses, the image quality of the printed product to be output among the plurality of image forming apparatuses without reducing the productivity.

To achieve at least one of the abovementioned objects, according to an aspect of the present invention, a system reflecting one aspect of the present inventions comprises the followings.

An image forming system including a plurality of image forming apparatuses, the image forming system including:
a hardware processor that determines an image formation condition for each of the plurality of image forming apparatuses based on sheet characteristic information corresponding to a characteristic of a sheet acquired from each of the plurality of image forming apparatuses.

To achieve at least one of the abovementioned objects, according to an aspect of the present invention, a device reflecting one aspect of the present inventions comprises the followings.

An information processing apparatus capable of executing distributed printing in which one print job is executed by a plurality of image forming apparatuses by controlling the plurality of image forming apparatuses, the information processing apparatus including:
a hardware processor that determines an image formation condition for each of the plurality of image forming apparatuses based on sheet characteristic information corresponding to a characteristic of a sheet acquired from each of the plurality of image forming apparatuses.

### BRIEF DESCRIPTION OF THE DRAWINGS

The advantages and features provided by one or more embodiments of the present invention will be understood more fully from the following detailed description and the accompanying drawings. However, these are for the purposes of example only and are not intended to limit the present invention.

FIG. 1 is a diagram illustrating a schematic configuration of an image forming system according to a first embodiment;

FIG. 2 is a schematic sectional view illustrating an overall configuration of an image forming apparatus;

FIG. 3 is a block diagram of the image forming apparatus;

FIG. 4 is a block diagram of an information processing apparatus;

FIG. 5 is a diagram indicating an example of items;

FIG. 6A is a diagram indicating image quality change characteristic information for each combination of items;

FIG. 6B is a diagram indicating the image quality change characteristic information for each combination of items;

FIG. 6C is a diagram indicating the image quality change characteristic information for each combination of items;

FIG. 7 is a diagram illustrating data details of the image quality change characteristic information;

FIG. 8 is a diagram illustrating data details of a plurality of pieces of the image quality change characteristic information;

FIG. 9 is a diagram illustrating data details of the image quality change characteristic information;

FIG. 10A is a flowchart illustrating distributed printing processing;

FIG. 10B is a subroutine flowchart illustrating image formation condition adjustment processing in step S03;

FIG. 10C is a subroutine flowchart illustrating the image formation condition adjustment processing in step S06;

FIG. 11 is a diagram illustrating an example of a common image quality setting screen displayed on an operation display and the like;

FIG. 12A is a schematic diagram for explaining adjustment of an image formation condition for equalizing the glossiness among the apparatuses;

FIG. 12B is a schematic diagram for explaining adjustment of the image formation condition for equalizing the glossiness among the apparatuses;

FIG. 13 is a subroutine flowchart in a modification example, illustrating the image formation condition adjustment processing performed subsequent to FIG. 10B;

FIG. 14 is a schematic diagram illustrating a state in which there is no overlap in an image quality change prediction width in one or some of the apparatuses;

FIG. 15 is a diagram illustrating an example of a notification screen to a user displayed on the operation display and the like;

FIG. 16A is a flowchart illustrating the distributed printing processing according to a second embodiment;

FIG. 16B is a subroutine flowchart illustrating the image formation condition adjustment processing in step S54; and

FIG. 17 is a schematic diagram for explaining adjustment of the image formation condition for equalizing the glossiness in an added apparatus with that of the apparatus in operation.

### DETAILED DESCRIPTION

Hereinafter, embodiments of the present invention will be described with reference to the accompanying drawings. However, the scope of the present invention is not limited to the disclosed embodiments. Note that in the description of the drawings, the same elements are denoted by the same reference signs, and redundant description thereof will be omitted. In addition, dimensional ratios in the drawings are exaggerated for convenience of description and may be different from actual ratios. In the present embodiment, a recording medium includes a printing sheet (hereinafter, simply referred to as a sheet) and various films. In particular, the sheet includes a sheet produced using mechanical pulp and/or chemical pulp that are derived from plants. Examples of the types of the sheets include a coated glossy sheet, a matte sheet, an uncoated plain sheet, and a high-quality sheet.

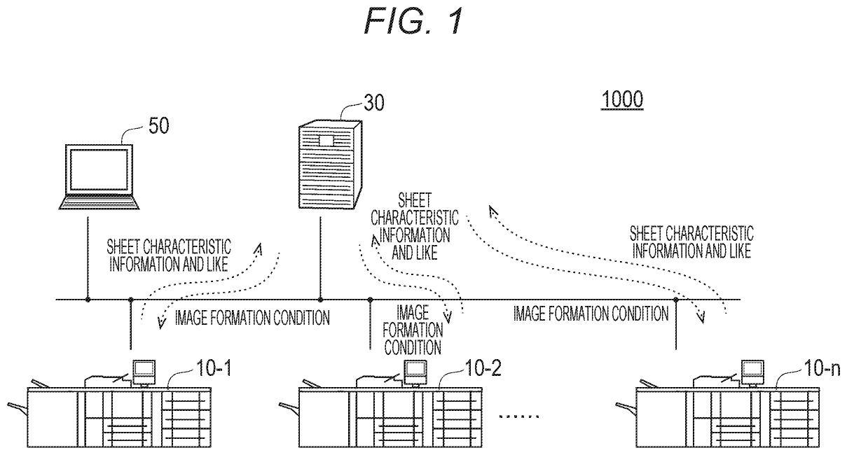

FIG. 1 is a diagram illustrating a schematic configuration of an image forming system 1000 according to a first embodiment. The image forming system 1000 includes a plurality of image forming apparatuses 10 (10-1 to 10-n) and an information processing apparatus 30. In addition, the image forming system 1000 may include a terminal device 50. The terminal device 50 is a PC, a tablet terminal, a smartphone, or the like, and is used by a user who executes distributed printing using the plurality of image forming apparatuses 10. These apparatuses are communicatively connected to each other via a network. The information processing apparatus 30 is an on-premise server located in a building where the image forming apparatuses 10 are installed, or a cloud server using a commercial cloud service. In distributed printing processing, the information processing apparatus 30 determines one or more image forming apparatuses 10 that execute the distributed printing from among the plurality of image forming apparatuses 10 to be controlled. In addition, a controller (that is, a hardware processor) of the information processing apparatus 30 determines an image formation condition of the image forming apparatus 10 that executes the distributed printing. Note that in the example illustrated in FIG. 1, the information processing apparatus 30 is configured independently of the image forming apparatuses 10, but any one of the plurality of image forming apparatuses 10 may function as the information processing apparatus 30. In this case, a controller 31 of the information processing apparatus 30 is incorporated in the image forming apparatus 10.

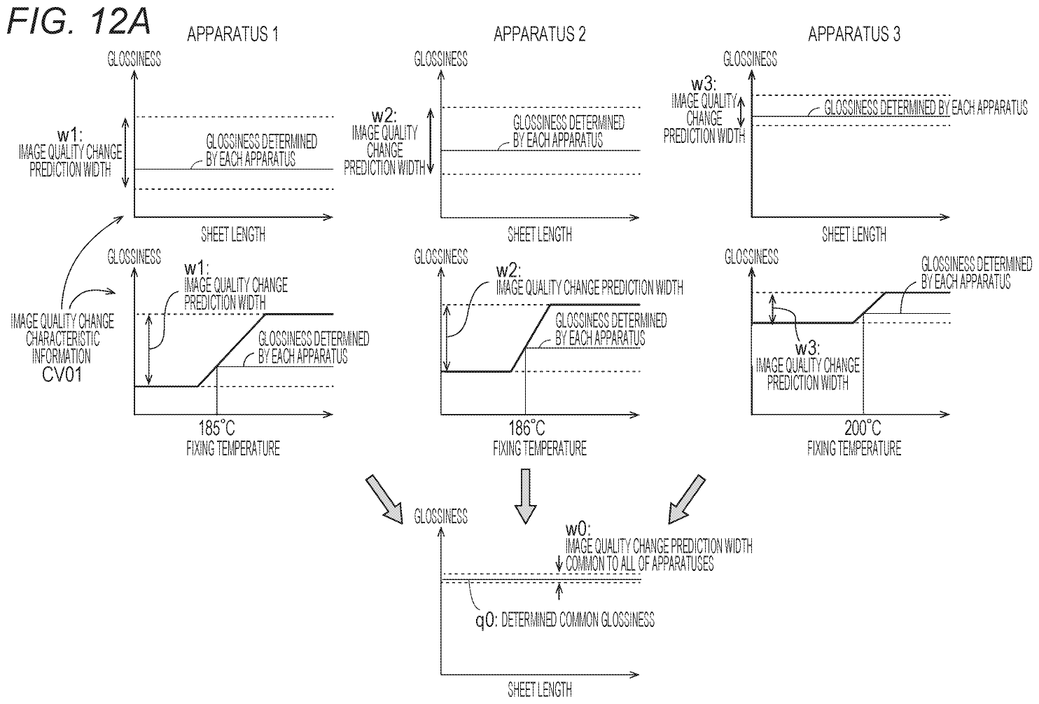

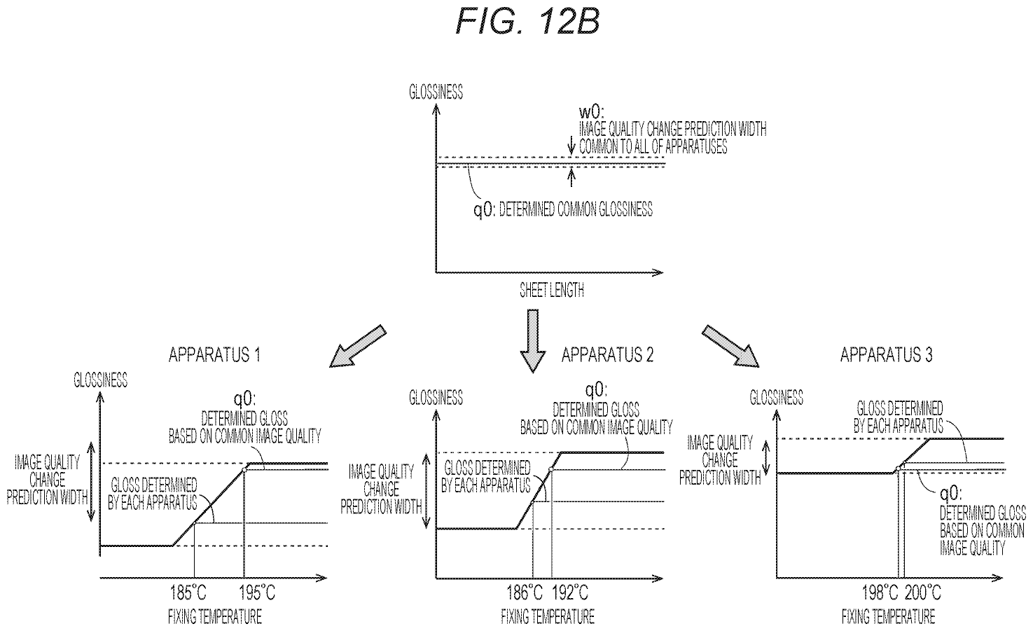

The information processing apparatus 30 acquires sheet characteristic information and apparatus information (hereinafter, collectively referred to as sheet characteristic information and the like) from each of the image forming apparatuses 10-1 to 10-n (hereinafter, collectively referred to simply as image forming apparatuses 10 or apparatuses). Then, the information processing apparatus 30 uses image quality change characteristic information to determine the image formation condition of each of the apparatuses based on the acquired sheet characteristic information and the like, and transmits the image formation condition to each of the image forming apparatuses 10. Processing of setting the image formation condition using the sheet characteristic information will be described below in detail (FIG. 12A, FIG. 12B, and the like).

### (Image Forming Apparatus 10)

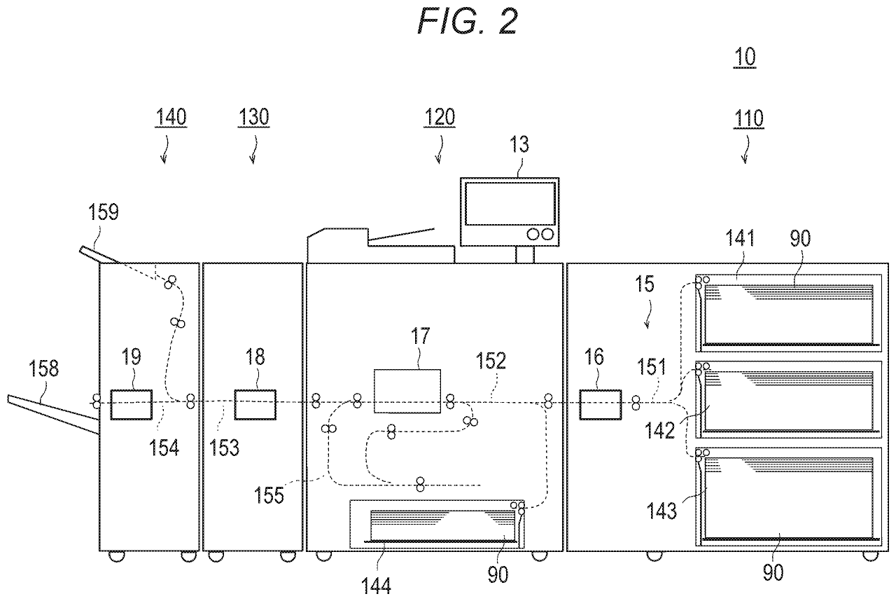

Hereinafter, the image forming apparatus 10 will be described with reference to FIG. 2 and FIG. 3. FIG. 2 is a schematic sectional view illustrating an overall configuration of the image forming apparatus 10. FIG. 3 is a block diagram of the image forming apparatus 10. As illustrated in FIG. 2, the image forming apparatus 10 includes a sheet feed device 110, an apparatus body 120, an inspection device 130, and a post-processing apparatus 140, which are mechanically and electrically connected to each other.

As illustrated in FIG. 2 and FIG. 3, the image forming apparatus 10 includes a controller 11, a storage 12, an operation display 13, a sheet feeder 14, a conveyer 15, a medium detector 16, an image former 17, an inspector 18, a post-processor 19, an environment detector 20, and a communicator 21.

### (1. Controller 11)

The controller 11, which includes a CPU, a ROM, a RAM, and the like, executes various kinds of processing by executing programs stored in the ROM and the storage 12, and performs control of each section of the apparatus and various kinds of arithmetic processing in accordance with the programs.

### (2. Storage 12)

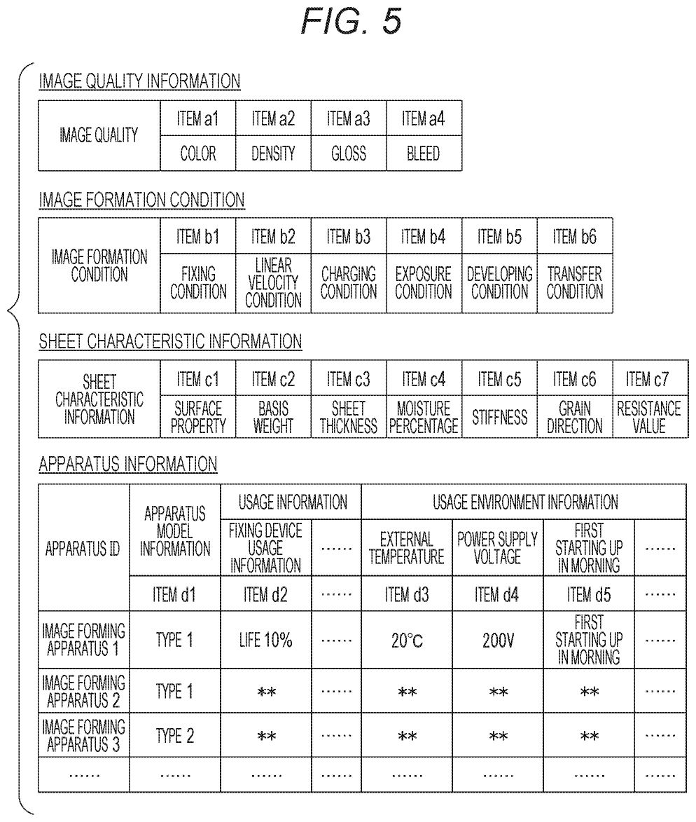

The storage 12 includes an auxiliary storage such as a hard disk that stores various kinds of programs and various kinds of data. The storage 12 stores the sheet characteristic information of the sheets stored in each of the sheet feed trays (sheet feed trays 141 to 144 to be described below). The sheet characteristic information includes detection data related to each of the sheet characteristics detected by the medium detector 16 and various kinds of information determined from the detection data. The various kinds of information include, for example, information of a sheet brand, size (sheet width and sheet length), a basis weight, and a sheet type (gloss coated paper, matte coated paper, plain paper, high-quality paper, rough paper, and the like). In addition, the storage 12 stores the apparatus information. The apparatus information includes apparatus model information, usage history information, and usage environment information (items d1 to d5 in FIG. 5 to be described below, and the like).

The apparatus model information includes an apparatus model, a hardware version, and a software version of the image forming apparatus 10 (or the apparatus body 120). The apparatus model is also referred to as a model number or a product name. The hardware version is referred to as a lot, and includes, for example, a version of an initial lot at the time of marketing, and a second and subsequent version after minor changes. The software version is a version of control software written in firmware (FW). The control software is appropriately updated by a service staff.

The usage history information includes a usage history of the apparatus itself (a usage period, the number of printed sheets, and the like), and a usage history of a replacement component of the apparatus (a usage time, the number of printed sheets, and the like). The usage history of the replacement component includes, for example, the number of used sheets and the usage time of each replacement component such as a fixing device, a photosensitive drum, a developing device, a charging device, and a cleaner. The usage history of the replacement component is reset upon replacement of the replacement component with a new one by the service staff in a predetermined maintenance cycle.

The usage environment information includes an external temperature, a power supply voltage of the commercial power supply connected to the image forming apparatus 10, and first starting up in the morning, and the like. The external temperature is detected by the environment detector 20. The first starting up in the morning refers to a state where the image forming apparatus 10 has started up (a state where the power is supplied to the heater of the fixing device) after a predetermined time (for example, four to eight hours or more) has elapsed since the image forming apparatus 10 was turned off (or the fixing device was turned off). The elapsed time or the time is measured by a timer function of the controller 11.

### (3. Operation Display 13)

The operation display 13, which includes a touch screen, a numeric keypad, a start button, a stop button, and the like, displays a state of the image forming apparatus 10, and is used for inputting settings and instructions regarding the distributed printing and other printing by the user.

### (4. Sheet Feeder 14)

The sheet feeder 14 includes large-capacity sheet feed trays 141 to 143 arranged in the sheet feed device 110, and a sheet feed tray 144 arranged in the apparatus body 120. Each of the sheet feed trays 141 to 144, which includes a delivery roller that delivers an uppermost sheet of a plurality of sheets 90 loaded and placed therein, delivers the sheets 90 in each of the sheet feed trays 141 to 144, one by one, to a conveyance path on the downstream side thereof.

### (5. Conveyer 15)

The conveyer 15 includes a plurality of conveyance paths 151 to 155, a plurality of conveyance roller pairs provided along the conveyance paths 151 to 155, and drive motors (not illustrated) that drive the conveyance roller pairs. As illustrated in FIG. 2, the conveyance path 151 is arranged in the sheet feed device 110, the conveyance paths 152 and 155 are arranged in the apparatus body 120, the conveyance path 153 is arranged in the inspection device 130, and the conveyance path 154 is arranged in the post-processing apparatus 140. In addition, the post-processing apparatus 140 on the most downstream side is provided with sheet ejection trays 158 and 159. For example, the sheet 90 conveyed from the sheet feed tray 141 is ejected, via the conveyance paths 151 to 154, to the sheet ejection tray 158. The conveyance path 155 is used for double-sided printing for forming an image also on the back surface of the sheet 90. After the image is formed on one surface (first surface) of the sheet 90 conveyed on the conveyance path 152, the sheet 90 is conveyed to the conveyance path 155 for the double-sided image formation. After the front and back of the sheet 90 conveyed to the conveyance path 155 has been reversed, the sheet 90 merges with the conveyance path 152 for the single-sided image formation, and an image is again formed on the other surface (second surface) of the sheet 90 by the image former 17.

### (6. Medium Detector 16)

The medium detector 16, which includes a plurality of detectors including a plurality of types of sensors different from each other, detects (determines) output values corresponding to a current, a voltage, a light receiving amount, and the like of each sensor, that is, sheet physical property information corresponding to the physical properties of the sheet 90 (sheet). The detection of the sheet 90 is executed, for example, every time new sheets 90 are loaded onto the sheet feed tray 141 and the like, or by an instruction by the user. The detected sheet characteristic information is stored in the storage 12 in association with the sheet feed tray.

The medium detector 16 is arranged on the upstream side with respect to the image former 17. In the example illustrated in FIG. 2, the medium detector 16 is arranged on the conveyance path 151 of the sheet feed device 110 and detects the sheet characteristic information of the sheet 90 to be conveyed. The medium detector 16 includes a surface property detector, a basis weight detector, a sheet thickness detector, a moisture percentage detector, a stiffness detector, a grain direction detector, and a volume resistance detector, which will be described below. Among these, the basis weight detector, the sheet thickness detector, and the moisture percentage detector can perform the measurement without stopping the sheet 90 being conveyed. That is, the basis weight detector, the sheet thickness detector, and the moisture percentage detector can perform the measurement while continuously conveying the sheets 90, without affecting the productivity. Note that the medium detector 16 does not necessarily have to include all of these detectors, and any of these detectors may be omitted. The medium detector 16 outputs the physical property information according to the measurement. The physical property information includes not only information that directly corresponds to the sheet physical property but also information obtained by converting one or more measurement values into the sheet physical property. Hereinafter, the sheet physical property directly obtained by the detectors and the measurement values are collectively referred to as the physical property information. The physical property information includes a plurality of items (smoothness, basis weight, thickness, moisture percentage (water content), stiffness, grain direction, and volume resistance (electrical resistance)) (items c1 to c7 in FIG. 5 to be described below).

### (6-1. Surface Property Detector)

The surface property detector detects a surface property of the sheet as the sheet characteristic information. The surface property detector, which includes a housing, a light emitter, a collimating lens, and a plurality of light receivers (optical sensors), optically detects the specular reflection light and the diffuse reflection light from the surface (irradiated surface) of the sheet, as described below. Accordingly, the characteristic of the coated layer of the sheet 90 is detected. One of guide plates in a sheet passing region on the conveyance path (conveyance path 151) is provided with an opening (measurement region), and the opening serves as an irradiation region for the light receiver. The sheet 90 conveyed to the opening is pressed by a pressing mechanism descends from above in the sheet passing region. Accordingly, the sheet 90 around the opening (of the guide plate) is pressed by the lower guide plate and the pressing mechanism from above. With this state, the irradiation light that has been substantially collimated by the collimating lens is emitted from the light emitter at an incident angle of 75 degrees with respect to the reference surface. The wavelength of the irradiation light is, for example, 465 nm. The plurality of light receivers receives the specular reflection light and the diffuse reflection light. The plurality of light receivers is arranged, for example, at three positions of reflection angles of 30 degrees (for diffuse reflection light), 60 degrees (for diffuse reflection light), and 75 degrees (for specular reflection light), or at two positions of 60 degrees and 75 degrees. Based on the absolute values and the ratio of the intensity of the light received by the respective light receivers, the surface property of the sheet 90 is detected. The glossiness (of white sheet) (for example, the specular glossiness at an incident angle of 75 degrees) is measured by the surface property detector. Note that the gloss property detected by the surface property detector is not limited to the glossiness, and may be another characteristic that is an index indicating the gloss.

### (6-2. Basis Weight Detector)

The basis weight detector detects the basis weight of the sheet as the sheet characteristic information. The basis weight detector, which is a sensor that detects the basis weight of the sheet 90, includes a light emitter and a light receiver and measures the basis weight by the attenuation amount of the light transmitted through the sheet 90. For example, the basis weight sensor includes the light emitter arranged on one side of the conveyance path 151 on which the sheet is conveyed and a light receiver arranged on the other side thereof, and detects the basis weight of the sheet 90 based on the intensity of the light that is transmitted through the sheet 90 and is received by the light receiver.

### (6-3. Sheet Thickness Detector)

The sheet thickness detector detects the thickness of the sheet as the sheet characteristic information. The sheet thickness detector includes a conveyance roller pair at least one of which is movable according to the thickness of the sheet 90 passing through the nip between the conveyance rollers and a measurement section that measures the distance between the shafts of the conveyance roller pair. The measurement section includes, for example, an actuator, an encoder, and a light emitter and a light receiver. A shaft position of the movable driven roller is displaced according to the thickness of the sheet 90 sandwiched by the conveyance roller pair. The sheet thickness detector measures the thickness of the sheet 90 by measuring the height of the displaced shaft.

### (6-4. Moisture Percentage Detector)

The moisture percentage detector detects the moisture percentage of the sheet as the sheet characteristic information. The moisture percentage detector measures, using an optical sensor, the moisture percentage (a physical property value related to the moisture amount, also referred to as water content) of the sheet 90 conveyed on the conveyance path. The moisture percentage detector includes a light emitting element, a light receiving element, and optical elements including a lens, an aperture, and a collimating lens, and the like. The moisture percentage detector irradiates the sheet 90 with light having a predetermined wavelength in a near-infrared region from the light emitting element, and detects the reflected light with the light receiving element. The moisture percentage detector detects the moisture percentage of the sheet by utilizing the property in which the absorptance of light having a predetermined wavelength in a near-infrared region changes according to the moisture percentage of the sheet 90.

### (6-5. Stiffness Detector)

The stiffness detector detects the stiffness of the sheet as the sheet characteristic information. The stiffness detector detects, with the leading end (or the trailing end) of the sheet 90 being a free end, the bending rigidity. The stiffness detector includes a holding member, a push-up member that pushes the sheet 90 upward from below, and a pressure detection sensor that detects the pressing force of the push-up member. The conveyance rollers are also used as the holding member. The contact surface of the push-up member with the sheet 90 is parallel to the axial direction of the conveyance rollers. The stiffness detector holds a portion slightly inside the end portion (edge) of the sheet 90 with the conveyance rollers and lifts up the leading end of the sheet 90 that is the free end with the push-up member, thereby measuring the stiffness of the sheet 90 based on the pressing force during lifting. The vertical movement of the push-up member is controlled by the drive motor, for example, a stepping motor. The stiffness detector uses the conveyance rollers as the holding member. In the stiffness detector, the contact surface of the push-up member with the holding region (roller nip) is both in the conveyance direction of the sheet 90 and in the direction orthogonal to the sheet surface (conveyance surface) of the sheet 90, and the stiffness detector detects the stiffness in the sheet conveyance direction.

### (6-6. Grain Direction Detector)

The grain direction detector detects the grain direction of the sheet as the sheet characteristic information. The grain direction detector has the similar configuration to the stiffness detector. The stiffness detector measures the stiffness in the sheet conveyance direction. Meanwhile, the grain direction detector is arranged such that the contact surface of the push-up member with the holding region is present in a direction intersecting the sheet conveyance direction. The grain direction detector is arranged such that the contact surface of the push-up member with the holding region is present in a direction inclined at a predetermined angle, for example, at 45 degrees or at 90 degrees with respect to the conveyance direction in a top view (as viewed from a direction perpendicular to the conveyance surface). In this case, a pair of plate members having a narrow width is used as the holding member. By comparing the stiffness in the direction inclined at a predetermined angle (for example, at 45 degrees) detected by the grain direction detector and the stiffness in the sheet conveyance direction detected by the stiffness detector, the controller 11 determines whether the grain direction (also referred to as the paper grain direction) of the sheet 90 is the grain long or the grain short.

### (6-7. Volume Resistance Detector)

The volume resistance detector detects the volume resistance of the sheet as the sheet characteristic information. The volume resistance detector detects the volume electrical resistance of the conveyed sheet 90. The volume resistance detector includes a pair of conveyance rollers that sandwich the sheet 90 and a high voltage (HV) unit. When the sheet resistance is measured, the drive motor of the conveyance rollers is stopped at a predetermined detection position on the conveyance path to temporarily stop the sheet 90. With this state, a high voltage is applied to the upper roller (also referred to as a detection roller) of the pair of conveyance rollers by the HV unit, then a value of a current flowing through the lower roller (counter roller) grounded via the sheet 90 is measured.

### (7. Image Former 17)

The image former 17 forms an image by, for example, an electrophotographic method. The image former 17 is arranged on the conveyance path 152 of the apparatus body 120, and forms an image on the conveyed sheet 90. The image former 17 includes four writing sections (not illustrated) corresponding to basic colors (Y, M, C, and K), four image forming units, and four primary transfer sections. The image former 17 also includes an intermediate transfer belt onto which the toner images formed by the respective image forming units are transferred and superimposed, a secondary transfer section, and a fixing device. The image forming units each include a photosensitive drum, a developing device, a charging device, and a cleaner (none of which is illustrated). The image forming units for the respective colors have the same configuration except for the color of toner inside the developing device. The fixing device, which includes a fixing roller, a heater, a temperature sensor, and the like, heats and pressurizes the toner image on the sheet 90 to fix the toner to the sheet 90. The fixing roller is heated to a predetermined temperature (referred to as fixing control temperature) by the heater.

### (7-1. Image Formation Condition)

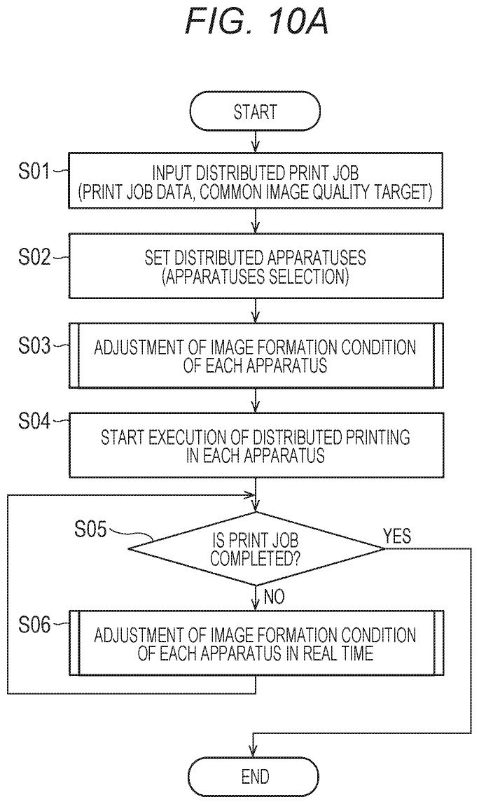

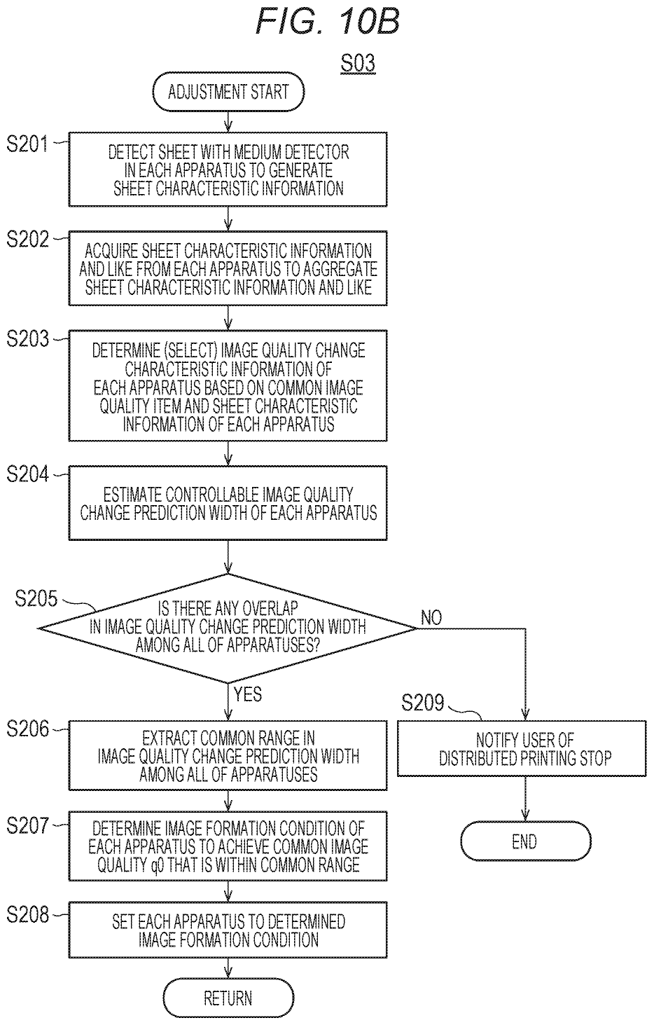

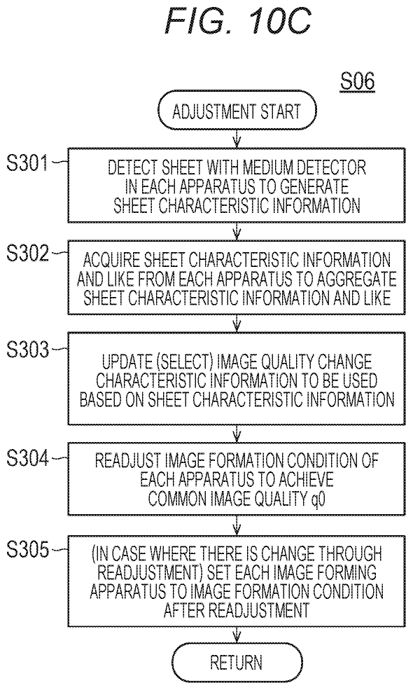

The image formation condition set by the controller 11 is set according to print settings of a print job and a detection result of the physical properties of the sheet 90 to be used that are detected by the medium detector 16. The image formation condition is also referred to as an image forming parameter or a process condition. The controller 11 sets the image formation condition with reference to a lookup table (LUT) stored in advance in the storage 12. In addition, in the present embodiment, when a predetermined print mode, such as the distributed printing, is executed, the image formation condition is determined and transmitted by the information processing apparatus 30 (FIG. 10A and the like to be described below). The image formation condition includes at least one of a fixing condition, a linear velocity condition, a charging condition, an exposure condition, a developing condition, and a transfer condition (items b1 to b6 in FIG. 5 to be described below). The fixing condition includes a fixing control temperature and a fixing pressing force in the fixing device. The linear velocity condition is also referred to as a process linear velocity, and is a linear velocity or a conveyance speed of the intermediate transfer belt, the fixing device, or the like. The charging condition is a power supply output (a grid voltage value or a discharge wire voltage value and a frequency) in the charging device. The exposure condition is the exposure amount of the writing section. The developing condition is a power supply output (a bias voltage, a peak voltage, and a frequency) to be applied to the developing rollers of the developing device. The transfer condition is, in a case where the intermediate transfer belt is used as described above, a secondary transfer output (a transfer current or a transfer voltage) and a transfer pressing force in the secondary transfer section.

### (8. Inspector 18)

The inspector 18 is arranged on the conveyance path 153 in the inspection device 130 and detects an image on the conveyed sheet 90. The inspector 18 includes a reader and a gloss meter.

### (8-1. Reader)

The reader is a so-called scanner and generates read image data by reading an image on the sheet. The reader is arranged on the conveyance path 153 downstream with respect to the image former 17. The reader may include two readers having a common configuration so as to be able to read images on both sides of the sheet 90 conveyed on the conveyance path 153. The reader reads an image on the sheet 90 formed by the image former 17 to generate the read image data. The reader includes a sensor array, an optical system, and an LED light source. The sensor array, in which a plurality of optical elements such as CCD is arranged in a line shape along the width direction (main scanning direction), is a color line sensor capable of reading the entire width range in the width direction of the sheet 90. The optical system includes a plurality of mirrors and lenses. The light from the LED light source irradiates the surface of the sheet 90 passing a reading position on the conveyance path 153. An image at the reading position is guided by the optical system and thus formed on the sensor array.

### (8-2. Gloss Meter)

The gloss meter measures the glossiness of an image. The glossiness measurement is performed by forming color patches (solid image) of toner on the sheet 90 and measuring the color patches. Formation of the color patches is performed by outputting dedicated chart document data in an evaluation mode. The gloss meter, which includes an irradiator and a light receiver, irradiates the color patches on the sheet 90 with light at a predetermined irradiation angle (for example, at 60 degrees or 75 degrees) to detect the light amount of the specular reflection by the light receiver.

### (8-3. Inspection Determinator)

The inspection determinator of the inspector 18 performs various kinds of inspections related to the image quality of a printed product by analyzing print data which serves as the source for printing and the read image data. In addition, the inspection determinator generates correspondence data between input and output by comparing and analyzing the pixel values of the print data and the pixel values of the read image data. For example, the inspection determinator generates the correspondence data between the image signal and the density or between the specific color based on the image signal and the output color. In addition, the inspection determinator evaluates the degree of bleed by comparing and analyzing the pixel values of the print data and the pixel values of the read image data.

(9. Post-processor 19) The post-processor 19 is arranged on the conveyance path 154 of the post-processing apparatus 140, and performs various kinds of post-processing on the sheet 90 according to the print settings. The post-processor 19 performs the post-processing, such as stapling processing, folding processing, and cutting processing on the sheet 90.

### (10. Environment Detector 20)

The environment detector 20 is a temperature and humidity sensor, and detects the external and surrounding temperature and humidity of the image forming apparatus 10. The detected temperature and humidity is updated in a predetermined cycle and stored in the storage 12. In addition, the image forming apparatus 10 includes a power supplier (not illustrated) that distributes power supplied from the commercial power supply to the inside of the apparatus. The power supplier detects an AC voltage value (for example, 100 V or 200 V) of the connected commercial power supply and outputs the AC voltage value to the controller 11. The controller 11 uses the AC voltage value of the commercial power supply as the usage environment information (item d4 in FIG. 5: power supply voltage).

### (11. Communicator 21)

The communicator 21 is an interface for network connection with the information processing apparatus 30, the terminal device 50, and other devices.

### (Information Processing Apparatus 30)

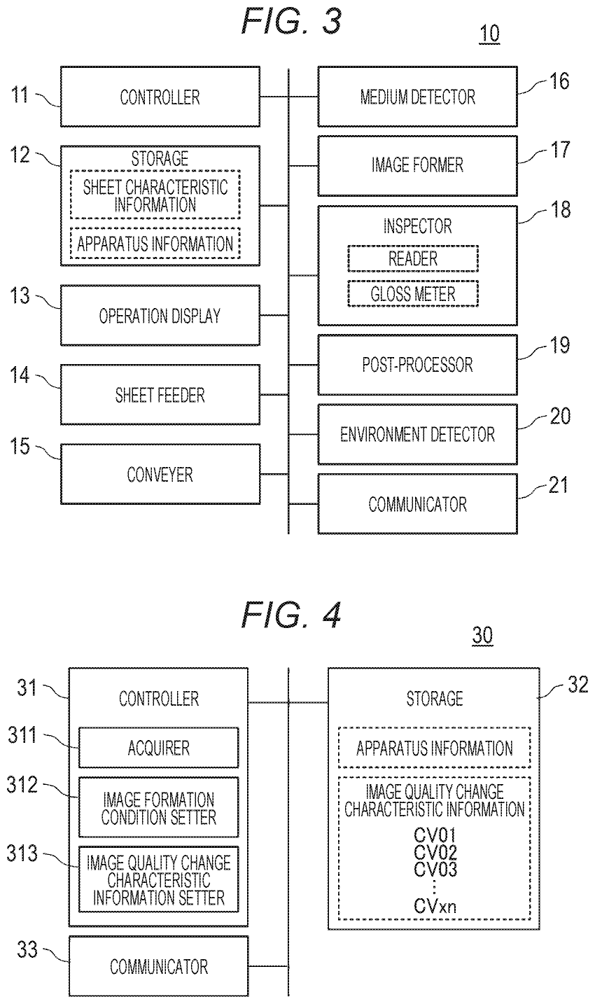

FIG. 4 is a block diagram of the information processing apparatus 30. The information processing apparatus 30 includes a controller 31, a storage 32, and a communicator 33.

### (Controller 31)

The controller 31, which includes a CPU, a ROM, a RAM, and the like, executes various kinds of processing by executing programs stored in the ROM and the storage 32, and performs control of each section of the apparatus and various kinds of arithmetic processing in accordance with the programs. The controller 31 determines the image formation condition for each of the plurality of image forming apparatuses 10 based on the sheet characteristic information corresponding to the sheet characteristics acquired from each of the plurality of image forming apparatuses 10.

The controller 31 may function as an acquirer 311 in cooperation with the communicator 33. In addition, the controller 31 may function as an image formation condition setter 312 and an image quality change characteristic information setter 313. The acquirer 311 acquires the sheet characteristic information corresponding to the sheet characteristics from each of the plurality of image forming apparatuses 10. The image formation condition setter 312 determines, based on the sheet characteristic information acquired by the acquirer 311, the image formation condition for forming an image on the sheet to be set for each of the plurality of image forming apparatuses 10. The image formation condition setter 312 determines, based on the sheet characteristic information of the sheet acquired by the acquirer 311 from each of the image forming apparatuses 10, the image formation condition for forming an image on the sheet. In addition, the image formation condition setter 312 determines whether or not the image quality of the printed product is equalized, that is, whether or not there is an overlap in an image quality change prediction width, based on the image quality change characteristic information (to be described below) applied to each image forming apparatus 10. In a case where the determination result is YES, the image formation condition setter 312 sets, using the image quality change characteristic information, the image formation condition to achieve the common image quality set within the overlap.

The image quality change characteristic information setter 313 generates or updates the image quality change characteristic information based on actual measured data. The actual measured data includes the image quality of the printed product analyzed from a reading value obtained by measuring the printed product with the reader and the gloss meter of the inspector 18, and the image formation condition and the sheet characteristic information of the printed product. Note that the controller 11 of the image forming apparatus 10 may also have the similar function to the image quality change characteristic information setter 313.

### (Storage 32)

The storage 32 includes an auxiliary storage such as a hard disk that stores various kinds of programs and various kinds of data. The storage 32 stores therein the apparatus information of each of the plurality of image forming apparatuses 10 included in the image forming system 1000. The apparatus information is periodically transmitted from the image forming apparatus 10. In addition, the storage 32 stores therein a plurality of pieces of the image quality change characteristic information (CV01 to CVn) in advance. The image quality change characteristic information defines the relation between the level of the image quality and the image formation condition according to (1) the sheet characteristic information or (2) the sheet characteristic information and the apparatus information with respect to each of a plurality of image quality items (items a1 to a4 in FIG. 5 to be described below) such as color, density, gloss, and bleed.

### (Communicator 33)

The communicator 33 is an interface for network connection with other devices.

### (Image Quality Change Characteristic Information)

Next, the image quality change characteristic information will be described with reference to FIG. 5 to FIG. 9.

FIG. 5 is a diagram indicating an example of the items related to the image quality change characteristic information. In the storage 32, the plurality of pieces of image quality change characteristic information is set and stored in advance. The image quality change characteristic information is a converter, such as a conversion table or a conversion function, in which input is the image formation condition and output is the image quality. The controller 31 selects, from among the plurality of pieces of image quality change characteristic information, one piece of the image quality change characteristic information according to selection conditions of image quality information, the sheet characteristic information, and the apparatus information. Alternatively, the controller 31 may acquire the closest two pieces of the image quality change characteristic information based on the image quality information, the sheet characteristic information, and the apparatus information, and interpolate the data according to the closeness to these pieces of the information (for example, the Euclidean distance) to set the image quality change characteristic information to be used. For example, in a case where there is no image quality change characteristic information for the moisture percentage of 4.5%, while the image quality change characteristic information for the moisture percentages of 5.0% and 4.0% are stored, an intermediate value between the image quality change characteristic information for the moisture percentages of 5.0% and 4.0% is used for the image quality change characteristic information for the moisture percentage of 4.5%. In addition, in a case of the moisture percentages of 4.1% to 4.9%, the interpolation is performed at a ratio corresponding to the distance (difference) between the moisture percentages of 5.0% and 4.0%. In addition, the similar interpolation processing can be performed on the basis weight and the like.

### (Output)

As indicated in the items a1 to a4 of the “image quality information” in FIG. 5, the image quality as the output of the image quality change characteristic information is set for the color, the density, the gloss, and the bleed.

### (Input)

In addition, as indicated in the items b1 to b6 in FIG. 5, the image formation condition as the input includes the fixing condition, the linear velocity condition, the charging condition, the exposure condition, the developing condition, and the transfer condition.

### (Selection Condition (Search Condition))

A first selection information used for selecting the image quality change characteristic information is the sheet characteristic information, which includes the surface property, the basis weight, the sheet thickness, the moisture percentage, the stiffness, the grain direction, and the resistance value (volume resistance value) of the items c1 to c7. The image quality changes depending on these items c1 to c7. For example, even under the same fixing condition, the image quality such as the glossiness of the printed product changes when the basis weight, the sheet thickness, or the moisture percentage of the sheet varies. For example, the greater the basis weight, the greater the sheet thickness, or the greater the moisture percentage, the higher the glossiness.

In addition, the apparatus information may be further used as a second selection information used for selecting the image quality change characteristic information. The apparatus information includes a plurality of types of information related to the apparatus model information, the usage history information, and the usage environment information of the items d1 to d5. Among these, the item d1 is the apparatus model information. The item d2 is the usage information of the fixing device, which indicates a ratio of a current usage amount to the usage amount when the usage amount for replacement (lifetime) is set to 100%. The item d3 is the external temperature. This is a current measurement value detected by the environment detector 20. The item d4 is a power supply voltage, which is detected by the power supplier. The item d5 is information indicating whether or not the current state is the above-described state of the first starting up in the morning.

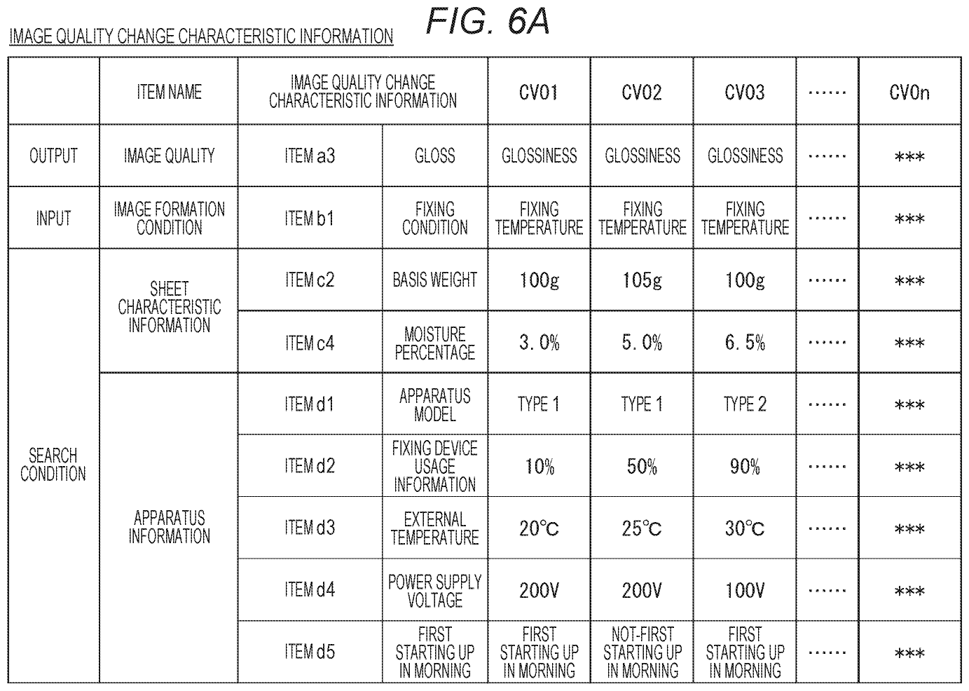

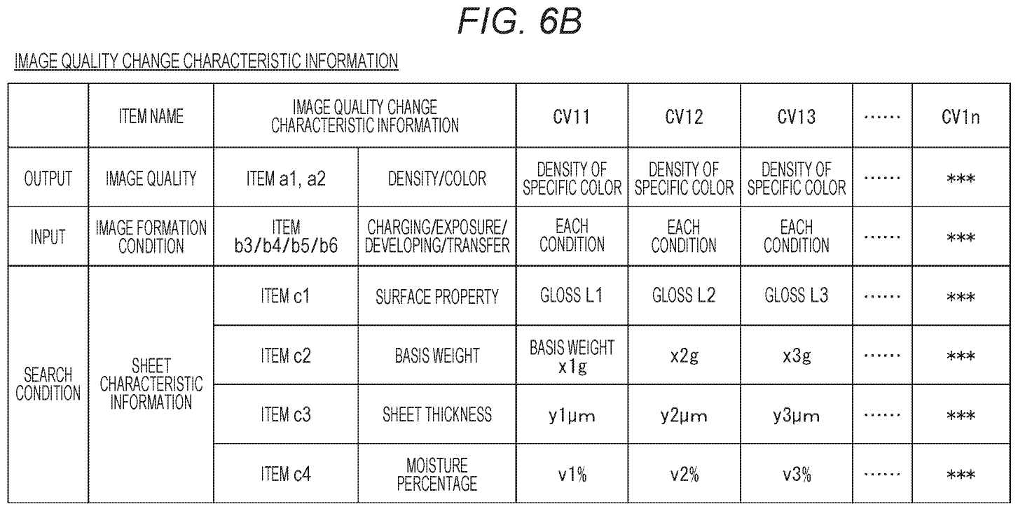

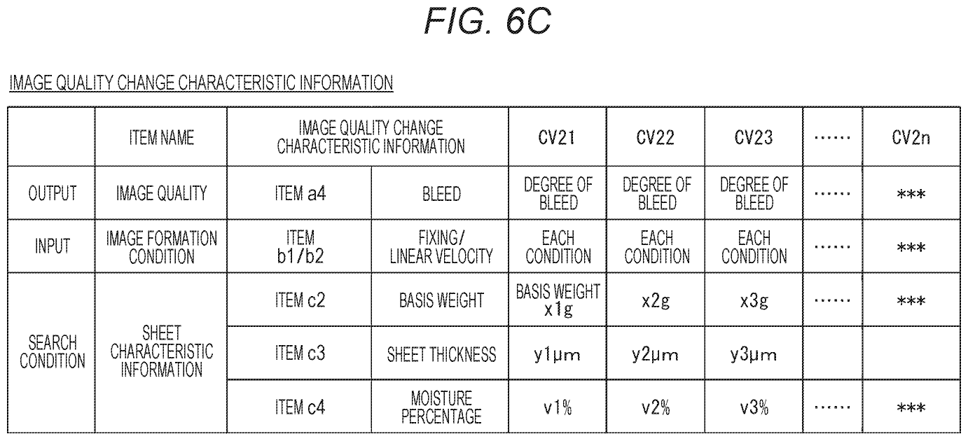

FIG. 6A, FIG. 6B, and FIG. 6C indicate examples of the image quality change characteristic information according to the selection conditions, the input, and the output as described above. In the example indicated in FIG. 6A, the search conditions are the items c2 and c4, and items d1 to d5, the image formation condition as the input is the item b1 (fixing condition), and the output is the item a3 (gloss).

In the example indicated in FIG. 6A, in a case where the items c2 and c4 are the basis weight of 100 g and the moisture percentage of 3.0%, and the items d1 to d5 are the apparatus model of type 1, the fixing device usage information of 10%, the external temperature of 20° C., the power supply voltage of 200 V, and the first starting up in the morning, the image quality change characteristic information CV01 is selected.

In the example indicated in FIG. 6B, the search conditions are the items c1 to c4, the image formation conditions as the input are the item b3 to b6, and the outputs are the item a1 (density) and the item a2 (color). In the example indicated in FIG. 6B, in a case where the item c1 is gloss L1 (indicating a certain level), the item c2 is the basis weight×1 g (indicating a certain value, the same applies hereinafter), the sheet thickness is yl m, and the moisture percentage is v1%, the image quality change characteristic information CV11 is selected. In the image quality change characteristic information CV11, as the grid voltage value (absolute value) of the charging device increases in the image formation condition b3 (charging condition) as the input, the output item a1 (density) increases and the output item a2 (color) increases (shifts to the color side of the basic color). For example, by increasing only the grid voltage value of the charging device of the image forming unit for the basic color Y as the charging device, the color shifts to the side where the color Y is intense in the output item a2 (color) (the same applies to the other image formation conditions b4 to b6 as the input below). In the image formation condition b4 (exposure condition) as the input, as the exposure amount of the writing section increases, the output item a1 (density) increases and the output item a2 (color) increases (shifts to the color side of the basic color). In the image formation condition b5 (developing condition) as the input, as the bias voltage (absolute value) applied to the developing rollers increases, the output item a1 (density) increases and the output item a2 (color) increases (shifts to the color side of the basic color). In the image formation condition b6 (transfer condition) as the input, as the secondary transfer output increases, the output item a1 (density) increases, and the output item a2 (color) increases (shifts to the color side of the basic color).

In the example indicated in FIG. 6C, the search conditions are the items c2 to c4, the image formation conditions as the input are the items b1 and b2, and the output is the item a4 (bleed). In the example indicated in FIG. 6C, in a case where the item c2 is basis weight×1 g, the sheet thickness is yl m, and the moisture percentage is v1%, the image quality change characteristic information CV21 is selected. In the image quality change characteristic information CV21, as the fixing temperature increases as the image formation condition b1 (fixing condition) as the input, the level of the output item a4 (bleed) increases (better/improved). In addition, as the process speed increases as the image formation condition b2 (linear velocity condition) as the input, the bleed level decreases (deteriorates), and as the process speed decreases, the bleed level increases.

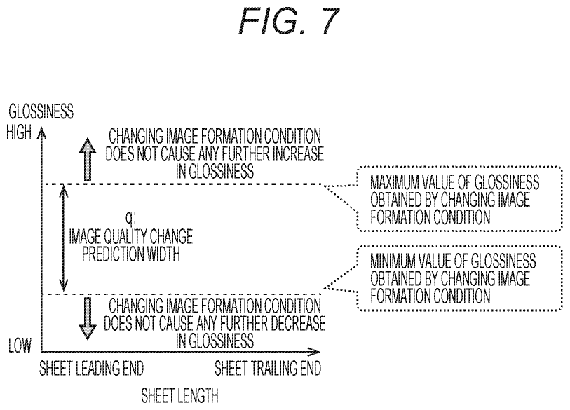

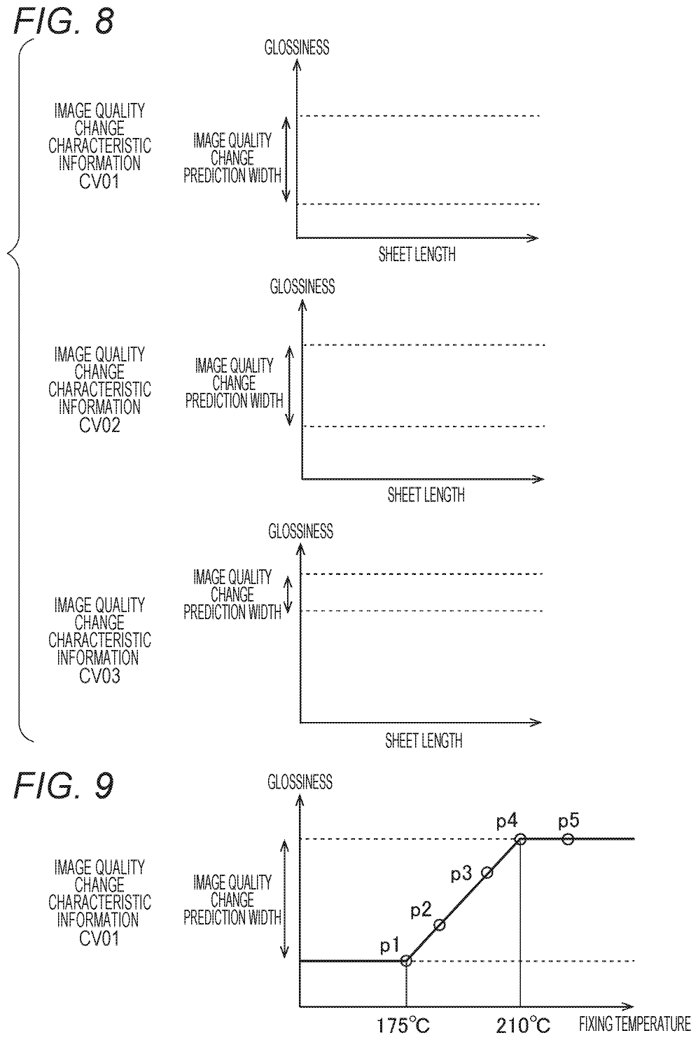

FIG. 7 is a diagram illustrating data content of the sheet characteristic information. The sheet characteristic information illustrated in FIG. 7 corresponds to the CV0n of FIG. 6A (for example, corresponds to CV01). FIG. 7 is a graph indicating the glossiness per sheet onto which an image is output, in which the horizontal axis represents the sheet length (sheet position) and the vertical axis represents the glossiness. As the image formation condition is changed, the glossiness can be adjusted within a certain range, but there are upper and lower limits. The glossiness exceeding the upper limit is not adjusted by changing the image formation condition within the range of the image formation condition that can be set, and the glossiness falling below the lower limit is not adjusted by changing the image formation condition. That is, the glossiness is adjusted only within the range of the image quality change prediction width. Similarly, the image quality change characteristic information on the image quality (items a1, a2, and a4) related to color, density, and bleed is adjusted only within the range of the image quality change prediction width. The image quality change prediction width indicates different widths and different values (absolute values) according to the sheet characteristic information and the apparatus information. FIG. 8 is a diagram illustrating the image quality change prediction width for each of the pieces of the image quality change characteristic information CV01 to CV03 illustrated in FIG. 6A. In each graph illustrated in FIG. 8, the vertical axis and the horizontal axis do not indicate any numerical value, but indicate the same scale and the same value. The image quality change characteristic information CV03 indicates that the glossiness is higher and the width is narrower than others. These pieces of image quality change characteristic information CV01 to CV03 may be created for each apparatus by detecting, by the inspection device 130, images formed in advance under a plurality of different image formation conditions. FIG. 9 is a graph illustrating a correspondence relationship with the glossiness when the fixing temperature as the image formation condition is varied under certain conditions (items c1 to c7 and items d1 to d5).

The image quality change characteristic information setter 313 of the information processing apparatus 30 generates or updates the image quality change characteristic information as illustrated in FIG. 9, based on the actual measured data (measurement values p1 to p5) acquired from the image forming apparatus 10. The actual measured data transmitted from the image forming apparatus 10 includes the sheet characteristic information of the sheet, the image formation condition (fixing control temperature) when the printed product is generated, and a measurement value of the glossiness of the printed product by the inspector 18. Note that each pieces of the image quality change characteristic information CV01 to CV03 and the like is described in two types of formats illustrated in FIG. 8 and FIG. 9. That is, each pieces of the image quality change characteristic information CV01 to CV03 and the like has two types of formats, which are the image quality change prediction width as illustrated in FIG. 8 and the input-output relationship (function) as illustrated in FIG. 9.

### (Distributed Printing Processing)

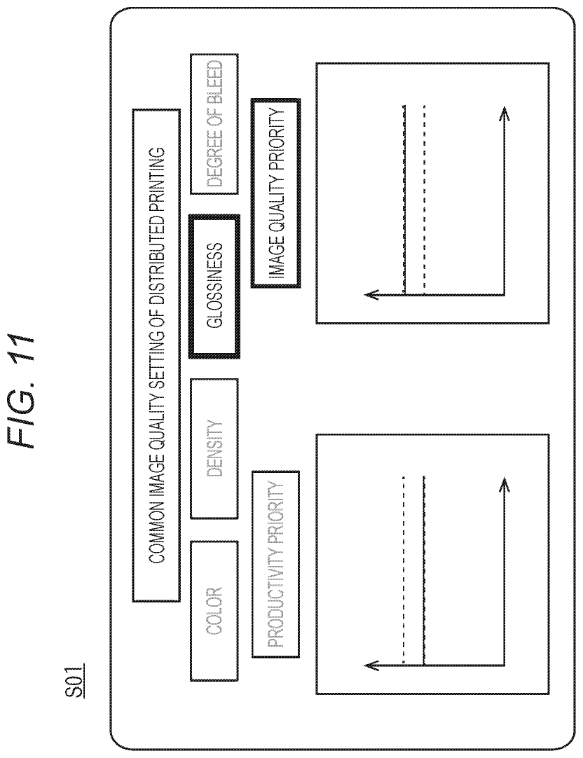

Next, with reference to FIGS. 10A to 12B, the distributed printing processing accompanied by image formation condition setting processing of each image forming apparatus by the information processing apparatus will be described. FIGS. 10A to 10C are flowcharts illustrating the distributed printing processing. FIG. 11 is an example of a common image quality setting screen displayed on the operation display 13 and a display of the terminal device 50 (hereinafter, referred to as operation display and the like).

### (Steps S01, S02)

In the step, the information processing apparatus 30 receives the input of a distributed print job through the user operation of the operation display 13 or through the terminal device 50. The distributed print job includes print data and a job setting. In the job setting, execution of the distributed printing is selected, and the target of the common image quality and its priority condition are described. The setting screen illustrated in FIG. 11 indicates that the user sets, among from the color, the density, the glossiness, and the degree of bleed (image quality items a1 to a4), the glossiness as the common image quality, and sets, among from productivity priority and image quality priority, the image quality priority as a priority condition. In addition, distributed apparatuses are set based on selection of the distributed apparatuses (the image forming apparatuses 10-1 to 10-n) (candidate apparatuses) described in the job setting. When the color is selected as the image quality by the user, a specific color among the colors included in the print data and a target value thereof are further set. When the density is selected as the image quality by the user, a target density of a representative color (for example, one or more of Y, M, C, and K) is further set. When the degree of bleed is selected as the image quality by the user, a target level of the degree of bleed is further set.

### (Step S03)

In the step, the controller 31 of the information processing apparatus 30 adjusts the image formation condition of each apparatus. FIG. 10B is a subroutine flowchart illustrating the processing of the step S03.

### (Step S201)

Among the plurality of image forming apparatuses 10, each image forming apparatus 10 set as the apparatus that executes the distributed printing detects the sheet 90 with the medium detector 16 included in each apparatus to generate the sheet characteristic information. Here, the sheet 90 stored in the sheet feed tray 141 and the like in which the sheets 90 that may be used for the distributed printing are stored is detected.

### (Step S202)

The acquirer 311 of the information processing apparatus 30 acquires the sheet characteristic information from each image forming apparatus 10 that executes the distributed printing.

### (Step S203)

The image formation condition setter 312 sets, for each image forming apparatus, the image quality change characteristic information of each apparatus based on the common image quality item set in step S01 and the sheet characteristic information acquired in step S202. The image formation condition setter 312 selects the matching image quality change characteristic information from among the plurality of pieces of the image quality change characteristic information CV01 to CVn stored in the storage 32. Alternatively, the image formation condition setter 312 determines the image quality change characteristic information to be applied from the closest one or two pieces of the image quality change characteristic information through the interpolation processing and the like.

### (Step S204, S205)

The image formation condition setter 312 estimates the controllable image quality change prediction width of each apparatus. FIG. 12A and FIG. 12B are schematic diagrams for explaining adjustment of the image formation condition for equalizing the glossiness among the respective apparatuses. Hereinafter, an example in which three image forming apparatuses 10 (also referred to as apparatuses 1 to 3) are set as the image forming apparatuses 10 that execute the distributed printing will be described. In addition, in the example, the pieces of the image quality change characteristic information CV01 to 03 are applied to the apparatuses 1 to 3, respectively. The image formation condition setter 312 estimates, according to each of the pieces of the image quality change characteristic information CV01 to CV03, the image quality change prediction width of each of all of the apparatuses that execute the distributed printing. In addition, the image formation condition setter 312 determines whether or not there is any overlap in the image quality change prediction width among all of the apparatuses. The image formation condition setter 312 proceeds with the processing to step S206 in a case where there is an overlap (S205: YES), and proceeds with the processing to step S209 in a case where there is no overlap (S205: NO).

### (Step S206)

The image formation condition setter 312 extracts a common range in the image quality change prediction width. In the example illustrated in FIG. 12A, it is indicated that there is the overlap between the image quality change prediction widths w1 to w3 of the apparatus 1 to the apparatus 3, and that the image quality change prediction width w0 common to all of the apparatuses exists. Note that in FIG. 12A and FIG. 12B, the image quality to be output under the image formation condition determined in a case where the printing is executed by a single apparatus, not as the distributed printing, is described as a reference (“glossiness determined by each apparatus”).

### (Step S207)

The image formation condition setter 312 sets a common image quality q0 within the common range. The setting may be performed according to the priority setting (the image quality priority or the productivity priority), or may be performed to a median value within the common range. Then, the image formation condition setter 312 determines the image formation condition of each apparatus to achieve the common image quality q0. For determining the image formation condition, the image quality change characteristic information (input-output format in FIG. 9) of each apparatus determined in step S203 is used.

### (Step S208)

The controller 31 of the information processing apparatus 30 sets each apparatus to the image formation condition determined in step S207. As illustrated in FIG. 12B, the image formation condition of each apparatus is determined to achieve the common image quality q0. Then, the processing of FIG. 10B is completed, and the processing returns to the processing in FIG. 10A (return).

### (Step S209)

On the other hand, if there is no overlap in the prediction width, the user is notified that the distributed printing cannot be executed. As the notification, for example, a warning is displayed on the operation display 13 or a warning is notified to the terminal device 50.

### (Step S04)

Upon receiving shared data of the print job, each apparatus starts execution of the distributed printing under the image formation condition set by the image formation condition setter 312.

### (Step S05)

The information processing apparatus 30 proceeds with the processing to step S06 in a case where the shared print job is not completed in any of the apparatuses. On the other hand, in a case where the shred print job is completed in all of the apparatuses, the distributed printing processing is completed (end).

### (Step S06)

In the step, the image formation condition of each apparatus is adjusted in real time. Here, the medium detector 16 continues to acquire the sheet characteristic information of the sheet 90 during the execution of the print job, as well. Then, upon change of the sheet characteristic information, the image formation condition is finely adjusted according to the real-time changed sheet characteristic information to enable maintenance of the common image quality set in step S11. For example, the moisture percentage of the sheet 90 may be different between the upper part and the center part of the stuck of the sheets placed on the sheet feed tray 141. In this case, the sheet characteristic information changes while images are continuously formed on the sheets 90. FIG. 10C is a subroutine flowchart illustrating the processing of the step S06.

### (Step S301)

For the distributed printing, the sheets 90 continuously fed and conveyed are detected by the medium detector 16 of each apparatus to generate the sheet characteristic information. For example, the moisture percentage detector among the sensors of the medium detector 16 performs measurement while the sheets 90 are being conveyed to generate the sheet characteristic information on the moisture percentage.

### (Step S302)

The acquirer 311 of the information processing apparatus 30 acquires the sheet characteristic information from each image forming apparatus 10 that is executing the distributed printing.

### (Step S303)

Only the sheet characteristic information, among the search conditions in step S203, is updated to the sheet characteristic information acquired in step S302, and the image quality change characteristic information to be used is updated (selected).

### (Step S304)

The image formation condition setter 312 readjusts the image formation condition using the updated image quality change characteristic information to achieve and maintain the common image quality q0 set in step S207.

### (Step S305)

The controller 31 of the information processing apparatus 30 sets each apparatus to the image formation condition determined in step S304. Note that in a case where there is no change from the image formation condition set in step S208 or the previous step S304, the processing of step S305 may be skipped. Then, the processing in FIG. 10C is completed, and the processing returns to the processing in FIG. 10A to repeat the processing in step S05 and subsequent steps.

### Modification Example

In step S209 in FIG. 10B according to the first embodiment, in a case of no overlap between the image quality change prediction widths of all of the image forming apparatuses 10 that are candidates for the distribution processing, the distributed printing is stopped. According to a modification example described below, in a case where there are three or more candidate apparatuses for the distributed printing and there is an overlap among some of the image forming apparatuses 10, the distributed printing is executed in the some of the image forming apparatuses 10.

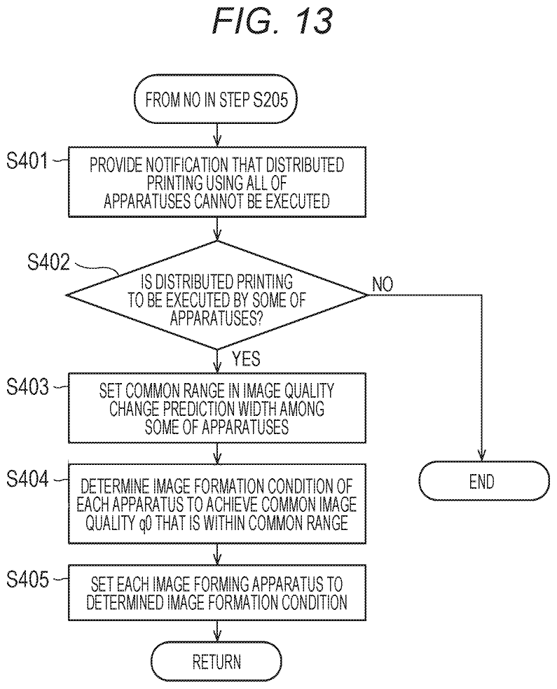

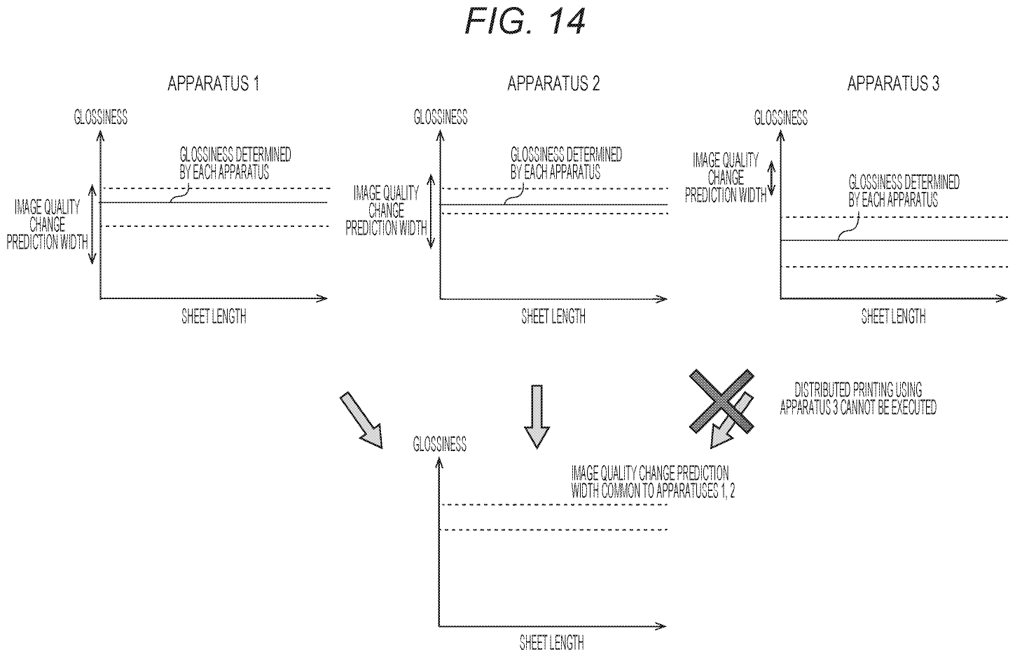

FIG. 13 is a subroutine flowchart illustrating image formation condition adjustment processing according to the modification example performed subsequent to step 205 instead of step S209 in FIG. 10B. FIG. 14 is a schematic diagram illustrating a state in which there is no overlap in the image quality change prediction width in one or some of the apparatuses. Hereinafter, for example, a case will be described in which two of the three image forming apparatuses executes the distributed printing when the image quality can be equalized by the two image forming apparatuses. FIG. 14 illustrates a state in which the image quality change prediction width of the apparatus 3 among the three apparatuses 1 to 3 set as targets of the distributed printing do not overlap those of the other apparatuses 1 and 2. In such a state, determination of NO is made in step S205 in FIG. 10B, leading to the processing in FIG. 13.

### (Step S401)

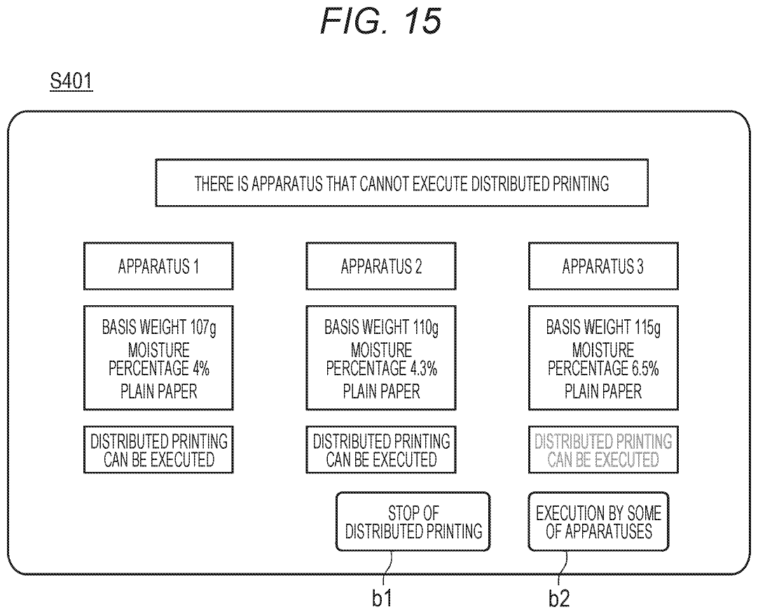

The information processing apparatus 30 provides notification that the distributed printing using all of the apparatuses cannot be executed. FIG. 15 is a diagram illustrating an example of a notification screen to the user displayed on the operation display and the like. FIG. 15 indicates that, among the apparatus 1 to the apparatus 3 set as targets of the distributed printing, the apparatus 3 cannot execute the distributed printing.

### (Step S402)

The information processing apparatus 30 completes the processing (end) in a case where the user gives an instruction to stop the processing (NO), or proceeds with the processing to step S403 in a case where the distributed printing is to be executed by some of the apparatuses (YES). For example, in a case where a stop button b1 is operated in FIG. 15, the processing is completed, and in a case where an execution button b2 is operated, the processing proceeds to step S403.

### (Steps S403 to S405)

The processing is similar to steps S206 to S208. The image formation condition setter 312 sets the common image quality q0 among some of the apparatuses, and sets the image formation condition of each of the apparatuses (apparatuses 1 and 2) using the image quality change characteristic information determined in step S203 to achieve the common image quality q0. Then, the processing in FIG. 13 is completed, and the processing returns to the processing in FIG. 10A to repeat the processing in step S04 and subsequent steps.

As described above, the image forming system according to the first embodiment includes the acquirer that acquires the sheet characteristic information corresponding to the characteristic of the sheet from each of the plurality of image forming apparatuses, and the image formation condition setter that determines, based on the sheet characteristic information acquired by the acquirer, the image formation condition for forming an image on the sheet for each of the plurality of image forming apparatuses. According to the image forming system, the image quality of the printed product to be output can be equalized among the plurality of image forming apparatuses in the distributed printing. In particular, according to the first embodiment, the image quality change characteristic information is not detected each time, but the predetermined image quality change characteristic information is used, so that the image quality of the printed product can be equalized without reducing the productivity.

### Second Embodiment

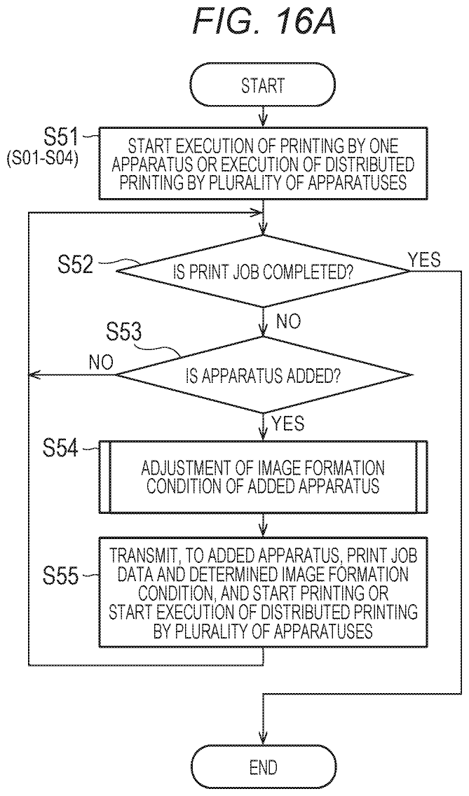

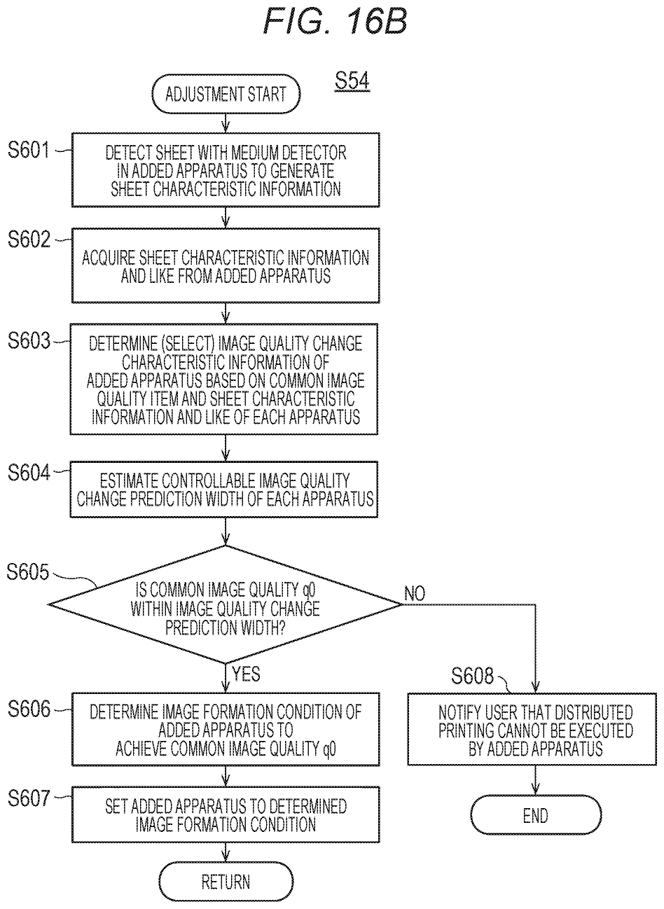

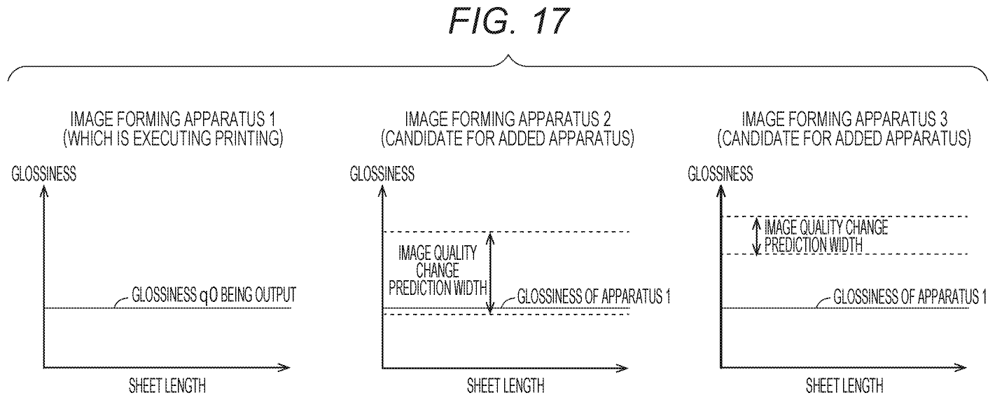

Next, distributed printing processing in the image forming apparatuses 10 according to a second embodiment will be described with reference to FIGS. 16A to 17. According to the second embodiment, an apparatus is added or replaced later during the execution of the distributed printing. This case includes a case where during the execution of printing by only one image forming apparatus (normal printing which is not the distributed printing) at first, an apparatus is added later, and the printing is switched to the distributed printing in the middle. Hereinafter, an apparatus to be added later is also referred to as an added apparatus.

FIG. 16A is a flowchart illustrating the distributed printing processing according to the second embodiment.

### (Step S51)

Based on the print job, (1) execution of the normal printing by one image forming apparatus is started, or (2) execution of the distributed printing by a plurality of image forming apparatuses is started. (1) In the normal printing, the image formation condition of the image forming apparatus 10 is set by the apparatus itself based on the job setting, and the sheet characteristic information and the like (conventional technique). Hereinafter, the image quality related to the common image quality item obtained under the image formation condition set by the apparatus itself in the normal printing is also referred to as the common image quality q0. The information processing apparatus 30 acquires the image formation condition, the sheet characteristic information, and the apparatus information from the image forming apparatus 10 in operation. Then, the common image quality q0 can be calculated based on the image quality change characteristic information determined from the sheet characteristic information and the apparatus information, and the image formation condition. In addition, (2) in a case of the distributed printing, execution of the distributed printing with the common image quality q0 is started in the processing of steps S01 to S04 described above (FIG. 10A, FIG. 10B).

### (Step S52)

In a case where the print job has not been completed, the information processing apparatus 30 proceeds with the processing to step S53. On the other hand, in a case where the print job in execution has been completed, the processing is completed (END).

### (Step S53)

In the step, the information processing apparatus 30 proceeds with the processing to step S54 in a case of input of a setting instruction by the user for adding an apparatus from the normal printing or for further adding an apparatus during the execution of the distributed printing (YES). On the other hand, in a case of no setting for adding an apparatus (NO), the processing returns to step S52.

### (Step S54)

In the step, the image formation condition of the added apparatus is adjusted. There may be a plurality of the added apparatuses. Hereinafter, an example in which the number of apparatuses currently executing the job is one (apparatus 1), and the number of candidates for the added apparatuses to be added later is two (apparatuses 2 and 3) will be described. FIG. 16B is a subroutine flowchart illustrating the image formation condition adjustment processing in step S54.

### (Step S601)

The added image forming apparatus 10 detects the sheet 90 with the medium detector 16 included in the added apparatus itself to generate the sheet characteristic information. Here, the sheet 90 stored in the sheet feed tray 141 and the like in which the sheets 90 that may be used for the distributed printing are stored is detected.

### (Step S602)

The acquirer 311 of the information processing apparatus 30 acquires the sheet characteristic information from the added apparatus.

### (Step S603)

The image formation condition setter 312 sets, for each image forming apparatus, the image quality change characteristic information of each apparatus based on the common image quality item set in step S51 and the sheet characteristic information acquired in step S601. The image formation condition setter 312 selects the matching image quality change characteristic information from among the plurality of pieces of the image quality change characteristic information CV01 to CVn stored in the storage 32. Alternatively, the image formation condition setter 312 determines the image quality change characteristic information to be applied from the closest one or two pieces of the image quality change characteristic information through the interpolation processing and the like.

### (Step S604, S605)

The image formation condition setter 312 estimates the controllable image quality change prediction width of each apparatus. FIG. 17 is a schematic diagram for explaining adjustment of the image formation condition for equalizing the glossiness among the apparatuses. An example will be described in which the pieces of the image quality change characteristic information CV01 to 03 are applied to the apparatuses 1 to 3, respectively. The apparatus 1 is the apparatus that is executing the printing, and the apparatuses 2 and 3 are the added apparatuses.

The image formation condition setter 312 estimates the common image quality q0 output by the apparatus 1 in operation according to the image quality change characteristic information CV01. In addition, the image formation condition setter 312 estimates, according to each of the pieces of the image quality change characteristic information CV02 and CV03, the image quality change prediction width of each of the added apparatuses 2 and 3 that are to execute the distributed printing. In addition, the image formation condition setter 312 determines whether or not the image quality q0 being output is within the image quality change prediction width of each added apparatus. In a case where the image quality q0 is within the image quality change prediction width (S605: YES), the image formation condition setter 312 proceeds with the processing to step S606. In the example illustrated in FIG. 17, the image quality q0 being output is within the image quality change prediction width of the added apparatus 2. Meanwhile, in a case where the image quality q0 being output is not within the image quality change prediction width of the added apparatus (S605: NO), the image formation condition setter 312 proceeds with the processing to step S608. In the example illustrated in FIG. 17, the image quality q0 being output is not within the image quality change prediction width of the added apparatus 3.

### (Step S606)

The image formation condition setter 312 determines the image formation condition of the added apparatus to achieve the common image quality q0. In the example illustrated in FIG. 17, the image formation condition of the added apparatus 2 is determined. For the determination, the image quality change characteristic information (input-output format in FIG. 9) determined in step S603 is used.

(Step S607) The controller 31 of the information processing apparatus 30 sets the added apparatus to the image formation condition determined in step S606. Then, the processing of FIG. 16B is completed, and the processing returns to the processing in FIG. 16A (return).

### (Step S55)

The information processing apparatus 30 transmits the print job data and the determined image forming condition to the added device. Upon receiving data, the added device starts execution of the distributed printing. Execution of the distributed printing by a plurality of image forming apparatuses is started.

As described above, the similar effect to that of the first embodiment can be obtained also in the second embodiment. Further, in the second embodiment, the image formation condition is determined for each image forming apparatus to equalize the image quality of the printed product output by the plurality of image forming apparatuses that executes the distributed printing, and in a case of adding the image forming apparatus that executes the distributed printing during execution of the distributed printing, the image formation condition is determined for the image forming apparatus to be added to match the image quality of the image forming apparatus to be added to the image quality of the image forming apparatus already executing the distributed printing. According to the second embodiment, an apparatus that executes the distributed printing can be added later, and even in that case, the image quality of the printed product to be output can be equalized among the plurality of image forming apparatuses.

The configuration of the image forming system, the information processing apparatus or the image forming apparatus described above is a main configuration for describing the features of the above-described embodiments, and are not limited to the above-described configuration and can be modified in various ways within the scope of the claims. In addition, a configuration included in a typical image forming system, a typical information processing apparatus, or a typical image forming apparatus is not excluded.

In addition, the embodiments may be applied in combination with each other. For example, the first and second embodiments and the modification example may be applied in combination with each other.

In addition, the means and method for performing various kinds of processing in the image forming system and the information processing apparatus according to the above-described embodiments can be implemented by either a dedicated hardware circuit or a programmed computer. The program may be provided by, for example, a computer-readable recording medium such as a USB memory or a digital versatile disc (DVD)-ROM, or may be provided online via a network such as the Internet. In this case, the program recorded on the computer-readable recording medium is usually transferred to and stored in a storage such as a hard disk. In addition, the program may be provided as independent application software or may be incorporated into software of an apparatus as one function of the apparatus.

Although the embodiments of the present invention have been described and illustrated in detail, the disclosed embodiments have been created for a purpose of illustration and example only, and not limitation. The scope of the present invention should be interpreted by the wording of the accompanying claims.

What is claimed is:

1. An image forming system including a plurality of image forming apparatuses, the image forming system comprising:
a hardware processor that determines an image formation condition for each of the plurality of image forming apparatuses based on sheet characteristic information corresponding to a characteristic of a sheet acquired from each of the plurality of image forming apparatuses.

2. The image forming system according to claim 1, wherein
the hardware processor determines, to equalize image quality of a printed product output by the plurality of image forming apparatuses, the image formation condition for each image forming apparatus.

3. The image forming system according to claim 1, wherein
distributed printing in which one print job is executed by the plurality of image forming apparatuses is executable.

4. The image forming system according to claim 1, wherein
the hardware processor determines expected image quality based on the sheet characteristic information using image quality change characteristic information of each of the plurality of image forming apparatuses, and
the hardware processor determines, to equalize image quality of a printed product output by the plurality of image forming apparatuses, the image formation condition for each image forming apparatus.

5. The image forming system according to claim 4, wherein
the hardware processor further determines the image quality change characteristic information to be used for each of the plurality of image forming apparatuses based on at least one piece of apparatus information on an apparatus model, an apparatus usage history, and an apparatus usage environment of each of the plurality of image forming apparatuses.

6. The image forming system according to claim 4, wherein
the image quality change characteristic information defines a relationship between the image formation condition to be set and image quality.

7. The image forming system according to claim 6, wherein
the hardware processor estimates an image quality change prediction width based on a range of the image formation condition that can be set using the image quality change characteristic information of each image forming apparatus, and determines an overlap in the image quality change prediction width among the plurality of image forming apparatuses, and
the hardware processor determines, in a case where there is the overlap, the image formation condition to achieve the image quality within an overlap range.

8. The image forming system according to claim 7, wherein
distributed printing in which one print job is executed by the plurality of image forming apparatuses is executable, and
the hardware processor determines, at execution of the distributed printing, that in a case where there is no overlap in the image quality change prediction width, the distributed printing cannot be executed, and notifies a user of a determination result.

9. The image forming system according to claim 7, wherein
the plurality of image forming apparatuses is three or more,
distributed printing in which one print job is executed by the plurality of image forming apparatuses is executable, and
the hardware processor determines, at execution of the distributed printing, in a case where there is the overlap in the image quality change prediction width among some of image forming apparatuses among from the plurality of image forming apparatuses, the image formation condition to achieve the image quality within the overlap range for each of the some of image forming apparatuses among which there is the overlap.

10. The image forming system according to claim 1, wherein
distributed printing in which one print job is executed by the plurality of image forming apparatuses is executable,
the hardware processor determines, to equalize image quality of a printed product output by the plurality of image forming apparatuses that execute the distributed printing, the image formation condition for each image forming apparatus, and
the hardware processor determines, in a case of adding the image forming apparatus that executes the distributed printing during execution of the distributed printing, the image formation condition for the image forming apparatus to be added to match the image quality of the image forming apparatus to be added to the image quality of the image forming apparatus already executing the distributed printing.

11. The image forming system according to claim 1, comprising:
an information processing apparatus connected to the plurality of image forming apparatuses, wherein
the hardware processor is incorporated in the information processing apparatus.

12. The image forming system according to claim 1, wherein
the hardware processor is incorporated in any one of the plurality of image forming apparatuses.

13. The image forming system according to claim 1, wherein
each of the plurality of image forming apparatuses includes a medium detector that acquires the sheet characteristic information.

14. The image forming system according to claim 13, wherein
the medium detector is arranged on an upstream side with respect to an image former on an internal conveyance path of the image forming apparatus.

15. The image forming system according to claim 13, wherein
distributed printing in which one print job is executed by the plurality of image forming apparatuses is executable, and
the hardware processor readjusts, during execution of the distributed printing, the image formation condition for forming an image on the sheet for each of the plurality of image forming apparatuses, based on the sheet characteristic information that has been acquired.

16. The image forming system according to claim 2, wherein
the image quality is at least one of color, density, glossiness, and a degree of bleed.

17. The image forming system according to claim 1, wherein
the image formation condition includes at least one of a fixing condition of a fixing device that heats and pressurizes the sheet to fix toner onto the sheet, and a conveyance speed of the sheet during image formation.

18. The image forming system according to claim 1, wherein
the sheet characteristic information includes at least one of a surface property, a basis weight, a sheet thickness, a moisture percentage, stiffness, and a grain direction of the sheet.

19. The image forming system according to claim 4, wherein
the image forming apparatus includes a reader that reads an image on the sheet after image formation on an internal conveyance path to obtain read image data, and
the image forming apparatus includes an image quality change characteristic information setter that generates or updates the image quality change characteristic information based on the sheet characteristic information of the sheet, the image formation condition, and the read image data.

20. The image forming system according to claim 1, wherein
the hardware processor includes an acquirer that acquires the sheet characteristic information corresponding to the characteristic of the sheet from each of the plurality of image forming apparatuses, and an image formation condition setter that determines, based on the sheet characteristic information acquired by the acquirer, the image formation condition for forming an image on the sheet to be set for each of the plurality of image forming apparatuses.

21. An information processing apparatus capable of executing distributed printing in which one print job is executed by a plurality of image forming apparatuses by controlling the plurality of image forming apparatuses, the information processing apparatus comprising:
a hardware processor that determines an image formation condition for each of the plurality of image forming apparatuses based on sheet characteristic information corresponding to a characteristic of a sheet acquired from each of the plurality of image forming apparatuses.

22. The information processing apparatus according to claim 21, wherein
the hardware processor includes an acquirer that acquires the sheet characteristic information corresponding to the characteristic of the sheet from each of the plurality of image forming apparatuses, and an image formation condition setter that determines, based on the sheet characteristic information acquired by the acquirer, the image formation condition for forming an image on the sheet to be set for each of the plurality of image forming apparatuses.

23. A non-transitory recording medium storing a computer readable control program, the control program being executed by a computer that controls an information processing apparatus capable of executing distributed printing in which one print job is executed by a plurality of image forming apparatuses by controlling the plurality of image forming apparatuses, for causing the computer to execute processing comprising:
a step of determining an image formation condition for each of the plurality of image forming apparatuses based on sheet characteristic information corresponding to a characteristic of a sheet acquired from each of the plurality of image forming apparatuses.
